(19) United States
(12) Patent Application Publication
(10) Pub. No.: US 2012/0244337 A1
(43) Pub. Date: Sep. 27, 2012

(54) FIBERIZED THERMOSET BINDER AND METHOD OF USING

(75) Inventor: Patrick Michael Gavin, Newark, OH (US)

(73) Assignee: OWENS CORNING INTELLECTUAL CAPITAL, LLC, Toledo, OH (US)

(21) Appl. No.: 13/069,475

(22) Filed: Mar. 23, 2011

(51) Int. Cl. B32B 17/02; D21H 13/36; B29C 47/88; C09D 105/00

(52) U.S. Cl. 428/293.4; 106/205.01; 162/145; 264/211.12

(57) ABSTRACT

A fiber is manufactured from thermosetting binder compounds by fiberizing an aqueous dispersion of thermoset compounds having a high solids content of at least 35%, 40% or 50% solids and/or a high viscosity of at least about 30 cps, 50 cps or 100 cps at room temperature. The fibers may be rotary fiberized or otherwise extruded. They may be co-fiberized with base fibers, including other polymeric fibers and/or inorganic fibers like glass fibers, or they may be intermingled post fabrication by other means, such as fluid dispersion processes or carding. The thermoset fibers are useful for binding together base fibers in fibrous products like glass fiber insulation.

### BACKGROUND

This invention relates in general to thermosetting binders used to make fibrous products, such as fiberglass insulation products. Fibrous glass insulation products generally comprise randomly-oriented glass fibers bonded together by a cured thermosetting polymeric material. Most typically, molten streams of glass are drawn into fibers of random lengths and blown into a forming chamber where they are randomly deposited onto a traveling conveyor, growing in thickness to become a fibrous pack. The fibers, while in transit in the forming chamber and while still hot from the drawing operation, are sprayed with an aqueous dispersion or solution of binder. In typical rotary fiber formers, binder is sprayed from outside the veil of glass fibers, but variations have included binder sprays from within the interior of the veil. A phenol-formaldehyde binder has been traditionally used throughout the fibrous glass insulation industry, although formaldehyde-free binders are also known.

The uncured fibrous pack is transferred to a curing oven where heated air, for example, is blown through the pack to cure the binder and rigidly bond the glass fibers together in a generally random, three-dimensional structure. Sufficient binder is applied and cured so that the fibrous pack can be compressed for packaging, storage and shipping, yet regains its thickness—a process known as “loft recovery”—when installed.

Alternatives to curable, thermosetting binders include thermoplastic polymer binders. Thermoplastic binders have been applied as hot sprays as described above which, upon cooling, hold glass fibers together in the bonded pack. Some thermoplastic binders have also been formed into fibers themselves, which fibers can be comingled with glass fibers to form a bonded pack. Some thermoplastic binders may be fiberized simultaneously with the glass fiber formation, a process known as co-fiberization, as taught in U.S. Pat. Nos. 5,523,031 and 5,523,032 to Ault, et al and U.S. Pat. Nos. 5,458,822, 5,490,961 and 5,736,475 to Bakhshi, et al. Also known is the use of similar thermoplastic polymers with base fibers made of other polymeric materials instead of the inorganic glass fiber.

Generally, thermoplastic binders are solids that must be heated to temperatures of 500-600 F or higher to render them soft enough to form fibers. In contrast, thermosetting binders are applied as relatively cool sprays of a thin, low viscosity aqueous solution. The use of cool aqueous binder dispersions has at least two disadvantages. First, it adds a great deal of moisture into a forming hood area; and second it causes cooling of the base fibers. Ultimately, a great deal of energy is required in the drying/curing oven to drive off all the moisture and to bring the pack up to a temperature where the binder will cure.

### SUMMARY OF THE INVENTION

In a first aspect, the invention relates to a fiber consisting essentially of curable thermoset compounds in an aqueous dispersion, said dispersion having at least one of the following properties: (a) a viscosity of at least about 30 centipoise (“cps”) at room temperature; and (b) a concentration of solids of at least about 35%. In some variations, the dispersion has a viscosity of at least about 50 cps, or at least about 100 cps and may be as high as 1000, or even 10,000 cps. In other variations, the dispersion may have a concentration of solids of at least about 40%, or at least about 50%, and may be as high as 75%, 80% or 90%.

The fiber may be made from a wide variety of thermosetting compounds, but typically from those having reactive carboxylic groups, reactive hydroxyl groups, reactive amide groups and/or reactive amine groups. In some embodiments, the thermoset compounds encompass polyacrylic binders, and in other embodiments, they are selected from carbohydrates and poly-carboxylic acids; and the polycarboxylic acids may be selected from citric, malonic, succinic and maleic. Alternatively, the thermoset compounds may be selected from phenolic and formaldehyde compounds.

In another aspect, the invention relates to a method of making a binding fiber, comprising forcing a viscous aqueous dispersion of a curable thermoset compound through an orifice to form a thermoset fiber, said aqueous dispersion having at least one of the following properties: (a) a viscosity of at least about 30 cps at room temperature; and (b) a concentration of solids of at least about 35%. As with the fiber itself, the dispersions may be even more concentrated, exhibiting a viscosity of at least about 50 cps, or at least about 100 cps or as high as 1000, or even 10,000 cps; and a concentration of solids of at least about 40%, or at least about 50%, and as high as 75%, 80% or 90%.

In one embodiment, the method comprises forcing a viscous aqueous dispersion through an orifice using centrifugal force in a rotary spinner. In other embodiments, the method comprises using a pressure head to force the aqueous dispersion through a bushing orifice or other die orifice.

In many embodiments, the method also involves blending the formed thermoset binder fiber with other polymeric or inorganic base fibers for form a curable matrix or pack. The method of blending the two types of fibers—base and binder—may be accomplished by cofiberization of the thermoset fiber and an inorganic mineral base fiber; or by carding the thermoset fiber and the base fiber together; or by fluid (air or water) dispersions of thermoset fibers and base fibers. Ideally the thermoset fiber is intricately intermingled with base fibers to form a pack of randomly oriented base fibers and thermoset fibers. Generally, the method further comprises curing the thermoset binder in the pack to form a fibrous product made by this process.

In a final aspect, the invention comprises an insulative fibrous product comprising:

a plurality of base fibers randomly oriented in a fibrous pack; and

a cured thermosetting binder securing the base fibers in random orientation within the fibrous pack, wherein the thermosetting binder originated as a plurality of binder fibers intermingled with the base fibers, the binder fibers consisting essentially of curable thermoset compounds in a fiberizable aqueous dispersion, said dispersion having at least one of the following properties: (a) a viscosity of at least about 30 cps at room temperature; and (b) a concentration of solids of at least about 35%.

The fibrous product may be made with any of the fiberized binder dispersions and compositions discussed herein, and with any of the base fibers discussed herein. It may be put to use in any of the applications of fibrous products, some of which are described herein.

An object and advantage of the invention is that less water is sprayed into the forming hood, causing a reduction in curing oven energy consumption.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a partially sectioned side elevation view of a forming hood component of a manufacturing line for manufacturing fibrous products;

FIG. 2 is an illustration of a mechanism for cofiberization of base fibers along with thermoset binder fibers; and

FIG. 3 is a graph illustrating the logarithmic relationship between % solids and viscosity of aqueous dispersions of thermoset binders.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including books, journal articles, published U.S. or foreign patent applications, issued U.S. or foreign patents, and any other references, are each incorporated by reference in their entireties, including all data, tables, figures, and text presented in the cited references.

In the drawings, the thickness of the lines, layers, and regions may be exaggerated for clarity.

Unless otherwise indicated, all numbers expressing ranges of magnitudes, such as angular degrees or sheet speeds, quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements. All numerical ranges are understood to include all possible incremental sub-ranges within the outer boundaries of the range. Thus, a range of 30 to 90 degrees discloses, for example, 35 to 50 degrees, 45 to 85 degrees, and 40 to 80 degrees, etc.

“Base fibers” refers to the principle fiber making up the three dimensional structure of a fibrous product. Base fibers may be polymeric thermoplastics or inorganic fibers. Base fibers have also been referred to as bulking fibers. “Mineral fibers” refers to any inorganic mineral material that can be melted to form molten mineral that can be drawn or attenuated into fibers. Glass is the most commonly used mineral material for fibrous insulation purposes and the ensuing description will refer primarily to glass fibers, but other mineral materials useful for insulation include rock, slag and basalt. Other thermoplastic polymeric fibers may also be used as the base fiber, e.g. polypropylene, polyethylene, polyethylene terephthalate (PET), etc.

### General Rotary Fiberization Process for Insulative Products

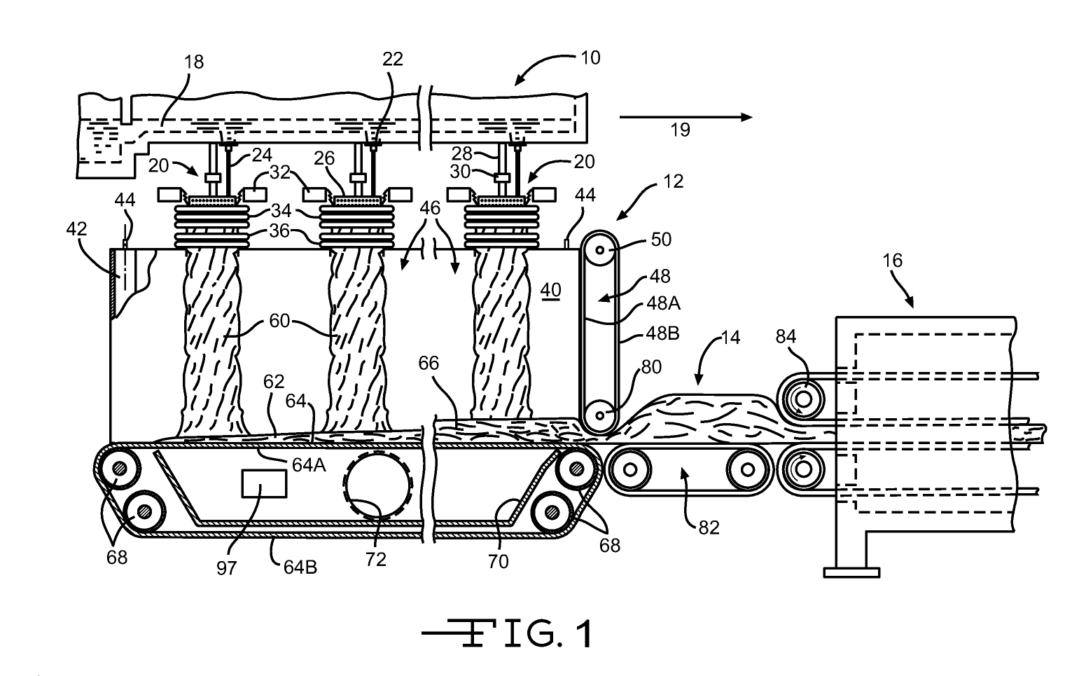

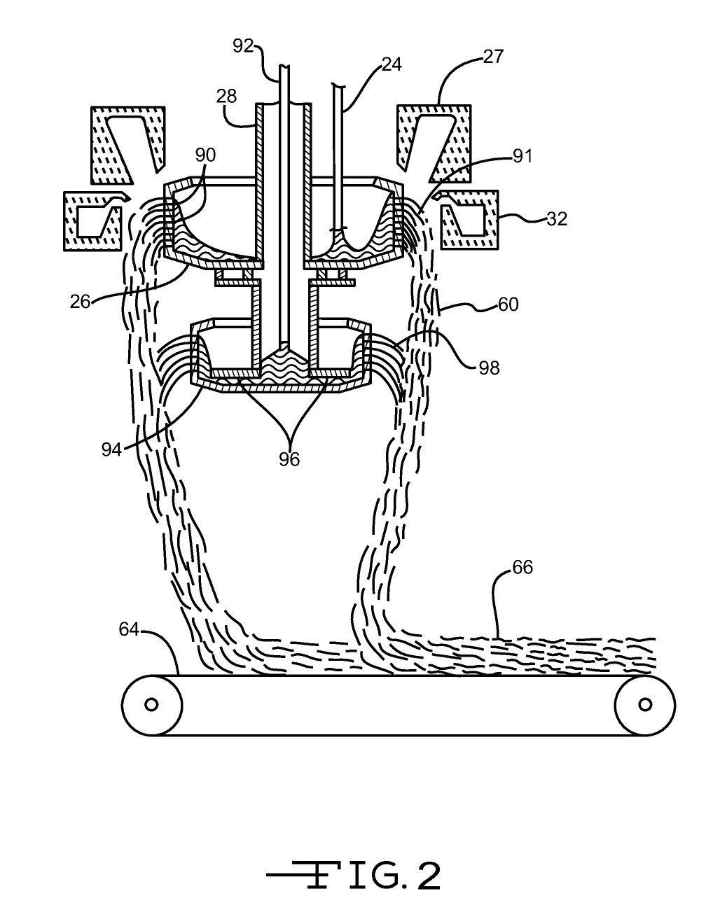

FIG. 1 illustrates a glass fiber insulation product manufacturing line including a forehearth 10, forming hood component or section 12, a ramp conveyor section 14 and a curing oven 16. Molten glass from a furnace (not shown) is led through a flow path or channel 18 to a plurality of fiberizing stations or units 20 that are arranged serially in a machine direction, as indicated by arrow 19 in FIG. 1. At each fiberizing station, holes 22 in the flow channel 18 allow a stream of molten glass 24 to flow into a spinner 26, which may optionally be heated by a burner 27 (shown in FIG. 2). Fiberizing spinners 26 are rotated about a shaft 28 by motor 30 at high speeds such that the molten glass is forced to pass through tiny holes in the circumferential sidewall of the spinners 26 to form primary base fibers 91 (see FIG. 2). Blowers 32 direct a gas stream, typically air, in a substantially downward direction to impinge the fibers, turning them downward and attenuating them into secondary fibers that form a veil 60 that is forced downwardly. The fibers are distributed in a cross-machine direction by mechanical or pneumatic “lappers” (not shown), eventually forming a fibrous layer 62 on a porous conveyor 64. The layer 62 gains mass (and typically thickness) with the deposition of additional fiber from the serial fiberizing units, thus becoming a fibrous “pack” 66 as it travels in a machine direction 19 through the forming area 46.

One or more cooling rings 34 spray coolant liquid, such as water, on veil 60 to cool the fibers within the veil. Other coolant sprayer configurations are possible, of course, but rings have the advantage of delivering coolant liquid to fibers throughout the veil 60 from a multitude of directions and angles. A binder dispensing system includes binder sprayers 36 to spray binder onto the base fibers of the veil 60. Illustrative coolant spray rings and binder spray rings are disclosed in US Patent Publication 2008-0156041 A1, to Cooper. Each fiberizing unit 20 thus comprises a spinner 26, a blower 32, one or more cooling liquid sprayers 34, and one or more binder sprayers 36. FIG. 1 depicts three such fiberizing units 20, but any number may be used. For insulation products, typically from two to about 15 units may be used in one forming hood component for one line.

The forming area 46 is further defined by side walls 40 and end walls 48 (one shown) to enclosed a forming hood. The side walls 40 and end walls 48 are each conveniently formed by a continuous belt that rotates about rollers 44 or 50, 80 respectively. The terms “forming hoodwall”, “hoodwall” and “hood wall” may be used interchangeably herein. Inevitably, binder and fibers accumulate in localized clumps on the hoodwalls and, occasionally, these clumps may fall into the pack and cause anomalous dense areas or “wet spots” that are difficult to cure.

The conveyor chain 64 contains numerous small openings allowing the air flow to pass through while links support the growing fibrous pack. A suction box 70 connected via duct 72 to fans or blowers (not shown) are additional production components located below the conveyor chain 64 to create a negative pressure and remove air injected into the forming area. As the conveyor chain 64 rotates around its rollers 68, the uncured pack 66 exits the forming section 12 under exit roller 80, where the absence of downwardly directed airflow and negative pressure (optionally aided by a pack lift fan, not shown) allows the pack to regain its natural, uncompressed height or thickness. A subsequent supporting conveyor or “ramp” 82 leads the fibrous pack toward an oven 16 and between another set of porous compression conveyors 84 for shaping the pack to a desired thickness for curing in the oven 16.

As the pack traverses the oven 16, heat and fans (not shown) are used to distribute heat throughout the pack to cure the binder. Typically, an oven 16 may comprise from 1 to 6 zones and the flow of heated air may be upward or downward in any particular zone. After the pack is cured (now known as a “blanket”) it may optionally be cut into sections for packaging, storing and shipping.

### Thermoset Binders

“Binders” are well known in the industry to refer to organic agents or chemicals, often polymeric resins, used to adhere inorganic or polymeric base fibers to one another in a three-dimensional structure that is compressible and yet regains its loft when compression is removed. Thermosetting binders are typically delivered as an aqueous dispersion of the binder chemical, which may or may not be soluble in water. “Binder dispersions” thus refer to mixtures of binder chemicals in a medium or vehicle. Dispersions may have more specific names depending on the nature of the dispersed phase and the nature of the vehicle or medium; but “dispersions” as used herein is generic for all such mixtures, including but not limited to true solutions, colloids, emulsions and suspensions.

Binder concentrates have been described, having a relatively high, fixed concentration, e.g. 20-40%, of binder solids, but these have been subsequently diluted with a binder “diluent” (typically more water) to produce a diluted “binder dispersion” having a lower concentration, e.g. 10%, of binder. This diluted, “ultimate” binder dispersion is then sprayed or dispensed on the fibers.

Binders fall into two broad, mutually exclusive classes: Thermoplastic and Thermosetting. See generally Allcock, Harry R., et al., Contemporary Polymer Chemistry, 3rd ed., Pearson Education, Inc., 2003, incorporated herein by reference. A thermoplastic material may be repeatedly heated to a softened or molten state and will return to its former state upon cooling. In other words, heating may cause a reversible change in the physical state of a thermoplastic material (e.g. from solid to liquid) but it does not undergo any irreversible chemical reaction. As Allcock states: “Basically, a thermoplastic is any material that softens when it is heated.” (Allcock, p. 12) Exemplary thermoplastic polymers include polyvinyls, polyethylene terephthalate (PET), polypropylene or polyphenylene sulfide (PPS), nylon, polycarbonates, polystyrene, polyamides, polyolefins, and certain copolymers of polyacrylates.

In contrast, “[t]he term thermosetting polymer refers to a range of systems which exist initially as liquids but which, on heating, undergo a reaction to form a solid, highly crosslinked matrix.” (Allcock, p. 15) Thus, thermosetting compounds comprise reactant systems—often pairs of reactants—that irreversibly crosslink upon heating. When cooled, they do not regain their former liquid state but remain irreversibly crosslinked. “In practical terms, an uncrosslinked thermoplastic material can be re-formed into a different shape by heating; a thermosetting polymer cannot.” (Allcock, p 16).

The reactants useful as thermosetting compounds generally have one or more of several reactive functional groups: e.g. amine, amide, carboxyl or hydroxyl. As used herein, “thermoset compound” (and its derivative clauses like “thermosetting compound,” “thermosetting binder” or “thermoset binder”) refers to at least one of such reactants, it being understood that two or more may be necessary to form the crosslinking system characteristic of thermosetting compounds. In addition to the principle reactants of the thermosetting compounds, there may catalysts, process aids, and other additive as described below.

Phenolic/formaldehyde binders comprise a thermosetting binder system that has been used in the past. Some manufacturers have attempted to use formaldehyde-free binder systems. Two main approaches to formaldehyde-free, thermosetting binder systems have been developed. First, there are the polyacrylic acid and polyol polymers. An example is the polyacrylic acid/polyol/polyacid acid binder system described in U.S. Pat. Nos. 6,884,849 and 6,699,945 to Chen, et al.

A second category of formaldehyde-free, thermosetting binders are referred to as “bio-based” or “natural” binders. “Bio-based binder” and “natural binder” are used interchangeably herein to refer to binders made from nutrient compounds, such as carbohydrates, proteins or fats, which have many reactive funcionalities. Because they are made from nutrient compounds they are very environmentally friendly. Unless context indicates otherwise (such as in the preceding paragraph), references in this application to binders, binder compositions or binder dispersions are referring to thermosetting binder systems.

### Carbohydrate Binder Compositions

Natural binders may be made from carbohydrates, including starches, pectins, dextrins, maltodextrins or other polysaccharides of varying length) coupled with polyfunctional carboxylic acids like citric acid. Exemplary carbohydrate based binder compositions are disclosed in commonly owned U.S. patent application Ser. No. 12/900,540, filed Oct. 8, 2010, and incorporated herein by reference. In one or more exemplary embodiments, the binder includes at least one carbohydrate that is natural in origin and derived from renewable resources. For instance, the carbohydrate may be derived from plant sources such as legumes, maize, corn, waxy corn, sugar cane, milo, white milo, potatoes, sweet potatoes, tapioca, rice, waxy rice, peas, sago, wheat, oat, barley, rye, amaranth, and/or cassaya, as well as other plants that have a high starch content. The carbohydrate polymer may also be derived from crude starch-containing products derived from plants that contain residues of proteins, polypeptides, lipids, and low molecular weight carbohydrates. The carbohydrate may be selected from monosaccharides (e.g., xylose, glucose, and fructose), disaccharides (e.g., sucrose, maltose, and lactose), oligosaccharides (e.g., glucose syrup and fructose syrup), and polysaccharides and water-soluble polysaccharides (e.g., pectin, dextrin, maltodextrin, starch, modified starch, and starch derivatives).

The carbohydrate polymer may have an average molecular weight from about 1,000 to about 8,000. Additionally, the carbohydrate polymer may have a dextrose equivalent (DE) number from 2 to 20, from 7 to 11, or from 9 to 14. The carbohydrates beneficially have a low viscosity and cure at moderate temperatures (e.g., 80-250° C.) alone or with additives. The low viscosity enables the carbohydrate to be utilized in a binder composition. In exemplary embodiments, the viscosity of the carbohydrate may be lower than 500 cps at 50% concentration and between 20 and 30° C. The use of a carbohydrate in the inventive binder composition is advantageous in that carbohydrates are readily available or easily obtainable and are low in cost.

In addition, the binder composition contains a crosslinking agent. The crosslinking agent may be any compound suitable for crosslinking the carbohydrate. In exemplary embodiments, the crosslinking agent has a number average molecular weight greater than 90, from about 90 to about 10,000, or from about 190 to about 4,000. In some exemplary embodiments, the crosslinking agent has a number average molecular weight less than about 1000. Non-limiting examples of suitable crosslinking agents include polycarboxylic acids (and salts thereof), anhydrides, monomeric and polymeric polycarboxylic acid with anhydride (i.e., mixed anhydrides), citric acid (and salts thereof, such as ammonium citrate), 1,2,3,4-butane tetracarboxylic acid, adipic acid (and salts thereof), polyacrylic acid (and salts thereof), and polyacrylic acid based resins such as QXRP 1734 and Acumer 9932, (“Acumer”) both commercially available from The Dow Chemical Company. In exemplary embodiments, the crosslinking agent may be any monomeric or polymeric polycarboxylic acid, such as citric, maleic, malonic, succinic, etc., and their corresponding salts. The crosslinking agent may be present in the binder composition in an amount up to about 50% by weight of the binder composition. In exemplary embodiments, the crosslinking agent may be present in the binder composition in an amount from about 5.0% to about 40% by weight of the total solids in the binder composition or from about 10% to about 30% by weight. Other potential agents and additives that may be present in the binder composition are described below.

### Non-Carbohydrate Binder Compositions

An alternative to the carbohydrate bio-based binder composition is a protein bio-based binder composition such as those described in U.S. patent application Ser. No. 12/776,703, filed May 10, 2010, and incorporated herein by reference. Such a binder includes a protein-containing biomass and a pH adjuster, and optionally, a crosslinking agent and/or a moisture resistant agent.

In exemplary embodiments, the binder composition includes at least one protein-containing biomass that is natural in origin and derived from renewable resources. For instance, the protein may be derived from plant sources, principally from legumes and nuts, or from animal sources. Well-known legumes include alfalfa, clover, peas, beans, lentils, lupins, mesquite, carob, soy, and peanuts. Of these, peas, beans, soy and peanuts are excellent source of protein. (See e.g. M. J. Messina, “Legumes and soybeans: overview of their nutritional profiles and health effects” in American Journal of Clinical Nutrition, Vol. 70, No. 3, 439S-450S, September 1999, incorporated by reference.) Specific beans high in protein include black, red, lima, chickpea, kidney, lentil, navy, mung, soy, pinto, and great northern. Other high protein plant sources include walnuts and peanuts. Alternatively, the protein may come from animal sources such as, but not limited to, eggs, blood, meat, and fish. In some exemplary embodiments, the protein-containing biomass contains up to about 95% protein, and in other exemplary embodiments, up to 50, 75 or 90% protein. The protein-containing biomass may be present in the binder composition in an amount from about 25% to about 99% by weight of the binder composition, or from about 50% to about 95% by weight.

Additionally, the protein bio-based binder composition contains a pH adjuster in an amount sufficient to adjust the pH to a desired level. The pH may be adjusted depending on the intended application, or to facilitate the compatibility of the ingredients of the size composition. In exemplary embodiments, the pH adjuster is utilized to adjust the pH of the binder dispersion to an acidic pH. Examples of suitable acidic pH adjusters include mono- or polycarboxylic acids, such as, but not limited to, citric acid, acetic acid, and sulfuric acid, anhydrides thereof, and inorganic salts that can be acid precursors. The acid adjusts the pH, and in some instances, acts as a crosslinking agent. The pH of the binder dispersion, when in an acidic state, may range from about 1 to about 6, and in some exemplary embodiments, from about 1 to about 5. In at least one exemplary embodiment, the pH of the binder dispersion is about 1. The pH adjuster in an acidic binder composition may be present in the binder composition in an amount from about 3.0% to about 20% by weight of the binder composition, or from about 5.0% to about 15% by weight.

In addition, the protein bio-based binder composition may contain a crosslinking agent, such as phenols (e.g., tannic acid), resorcinol, polyamines, polyimines, glyoxal, glutardialdehyde, malose, polycarboxylic acids, esters of polycarboxylic acid and combinations thereof. The crosslinking agent may be present in the binder composition in an amount up to about 20.0% by weight of the binder composition. In exemplary embodiments, the crosslinking agent may be present in the binder composition in an amount from about 5.0 to about 20.0% by weight of the binder composition, or from about 7.0 to about 15.0% by weight. Other potential agents and additives that may be present in the binder composition are described below.

Finally, it is envisioned that bio-based binder compositions may be produced from nutrient oils, fats, waxes and other hydrocarbon-based compounds that are not classified as carbohydrate or protein. Since such nutrients may provide a source of energy that supports organism growth, they are included within the bio-based binders described herein.

### Additives to Binder Compositions

In each of the carbohydrate and non-carbohydrate classes of binder compositions, other additives and agents may be present in the composition, each at its known or typical effective level. For example, catalysts (e.g. typically an alkalai metal salt of a phosphorous-containing acid, such as sodium hypophosphite, sodium phosphate, potassium phosphate, disodium pyrophosphate); silanes or other coupling agents; process aids for enhanced pack formation, such as polyols, viscosity modifiers, surfactants, defoaming agents, dust reducers, and lubricants; corrosion inhibitors; buffers; crosslinking density enhancers or facilitators; moisture resistance agent; extenders; and additives like dyes, pigments, colorants, UV stabilizers, emulsifiers, preservatives and the like, all may also be present. Additives may or may not also serve as a nutrient base for organism growth. If they are a nutrient base, such as vegetable oils in current use as de-dusters emulsions in binder dispersions, they may also benefit from the incorporation of biocides.

Additionally, fillers may be used as additives. Fillers may increase the solids content and consequently the viscosity of binder dispersions, but may or may not contribute to the binding capacity of the binders so made. While not necessary in most cases, solid fillers may be useful to afford sufficient viscosity for fiberization when low levels of binder are desired for product application. All such additives mentioned in this and the preceding paragraph, specifically including fillers, are not intended to be excluded by use of the term “consisting essentially of” as used herein.

### Thermoset Binder Fibers

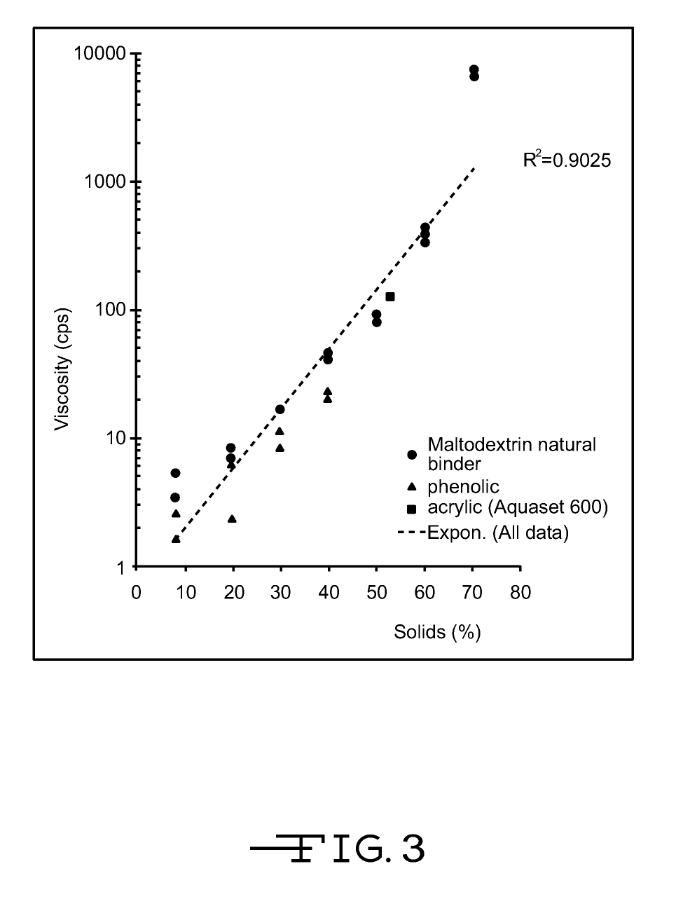

The aqueous dispersions from which the thermoset binder fibers are formed must have sufficiently high viscosity to form fibers. For purposes of this application, viscosity is measured with a Brookfield viscometer at room temperature. Selection of suitable spindles and speeds using a Brookfield viscometer is within the purview of one having ordinary skill in the art. Generally a viscosity of at least about 30 centipoise (cps) is required, e.g. from about 30 to about 50,000 cps. In some embodiments the viscosity may be from about 50 to about 10,000 cps, or from about 100 to about 1000 cps. As a generally rule, viscosity correlates to some extent with the solids content of the dispersion (see FIG. 3). Thus, it is possible to characterize the dispersion that forms thermoset fibers on the basis of solids content as well. Although it may be dependent to some extent on the exact nature of the binder composition, generally a solids content of at least about 35% is required, e.g. from about 35% to about 90%. In some embodiments the percent solid content may be from about 40% to about 80% or from about 50% to about 75%.

Thermoset fibers produced may have a wide variety of diameters and lengths. For example, fiber diameters may be in the range of from about 0.1 microns to more than about 80 microns with a fairly wide degree of variation, e.g. standard deviations of from about 1 to about 20. Depending on the desired use, average or mean fiber diameter may be targeted between about 1 micron and about 10 microns, more typically from about 3 microns to about 8 microns. In some embodiments, the diameter variability is such that at least about 80% or at least about 90% of the fibers have a diameter less than about 15 microns; in other embodiments at least about 50% or at least about 70% of the fibers have a diameter less than about 10 microns. Depending in part on the method of manufacture, the length of thermoset fibers can vary greatly from very short to essentially continuous, and may have great variation in length. Typical thermoset fibers can have an average length from about 0.1 inches to continuous, more typically from about 0.2 inches to about 10 inches, but this depends greatly on the intended use. Given the wide variability, individual fiber lengths may range from a minimum of about 0.001 inches to a maximum of continuous, more typically from about 0.01 inches to about 60 inches. Longer fibers may always be chopped to shorter lengths if desired for a particular use.

In general, any process useful for making fibers may be used to make thermoset binder fibers provided undue heat is not applied to cause premature curing. Generally the process will involve drawing, attenuation and/or extrusion of the viscous dispersion. In at least one embodiment, fibers are spun using centrifugal force to force the viscous aqueous dispersion through tiny orifices to form the fiber. This rotary process is described in more detail below in connection with co-fiberizing as a means for blending base fibers and thermoset binder fibers, and has proven to be a suitable method to overcome the surface tension of highly viscous aqueous dispersions. In general, the greater the centrifugal force driving the extrusion, the thinner the spun fiber, other conditions being equal. Alternatively, thermoset binder may be formed by extrusion of the viscous dispersion through a suitable die orifice under suitable pressure. As is known in the art, die orifice geometry may enhance fiber formation by countering surface tension. Melt blowing is another alternative to rotary fiberizing, and is well known and commonly used in the art to form thermoplastic polymer fibers.

Once a thermoset fiber is prepared using any of the methods above, it may be used immediately—as in cofiberizing—or stored for future blending operations as described below. The thermoset fibers may be hygroscopic and take up water from the atmosphere so storage under dry conditions is desirable to prevent the fibers from becoming too tacky prior to use for blending. However, once the blending operation is begun, the ambient humidity and or the addition of very small quantities of water will render the fibers tacky and suitable for use as binder fibers in an intermingled fibrous product. This reduces the amount of heat energy needed to cure the pack in the drying/curing oven.

Without intending to be limited by any particular theory, it is believed that the extrusion process is able to form fibers from an aqueous dispersion by evaporating a portion of the aqueous medium or vehicle and further concentrating the binder chemicals. This is thought to allow sufficient cohesive force to develop among the molecules of the polymeric binder components, particularly when the polymeric components exhibit non-Newtonian properties and have shear-thinning behavior. For purposes of the invention, the cohesiveness binder fibers made from aqueous dispersions of thermosetting binder compositions need not demonstrate substantial tensile strength, but rather need only demonstrate persistence for the necessary handling, processing and distribution into the fibrous matrix of base fibers to form a more-or-less homogenous mixture of intermingled fibers that can be moved to an oven for curing.

### Processes of Blending Thermoset Binder Fibers and Base Fibers

The thermoset binders of the invention may be used to manufacture fibrous products such as filters and insulation products. These products are generally non-woven products comprising base fibers randomly oriented and held in place by chemically by the thermosetting binder. Virtually any method of blending the base fibers and the thermoset binder fibers can be used. For example, the fibers may be blended in carding operation, as is typical for textile fibers. Alternatively, the two types of fibers may be uniformly dispersed and blended within a fluid, as in a conventional wet-laid process (the fluid being water) or a conventional air-laid process (the fluid being air).

In some embodiments, the thermoset fiber is spun simultaneously with formation of the base fiber in a process known as cofiberization. FIG. 2 illustrates a cofiberization apparatus, as well as an enlarged view of a single spinner 26 shown in FIG. 1. As described above, a stream of molten glass 24 flows into a spinner 26, which may optionally be heated by a burner 27. The spinner 26 is rotated about a shaft 28 such that the molten glass is forced to pass through tiny holes or orifices 90 in the circumferential sidewall of the spinner 26 to form primary base fibers 91. Blowers 32 direct a gas stream, typically air, in a substantially downward direction to impinge the fibers, turning them downward and attenuating them into secondary fibers that form a veil 60 that is forced downwardly.

For cofiberization, the shaft 28 may be hollow, so that a conduit 92 may be inserted in the interior of shaft 28 to deliver thermosetting binder to a secondary spinner 94 which contains a well 96 of thermoset binder at the bottom of the secondary spinner 94. Secondary spinner 94 also rotates about the axis of conduit 92 to spin thermosetting fibers 98 outwardly through tiny orifices in the sidewall of secondary spinner 94. The secondary spinner 94 may be attached to and rotate at the same rate as the spinner 26, or they may be decoupled and rotate at different speeds. These thermosetting fibers 98 intermingle with the base fibers in the veil 60 as it is directed downward to the conveyor to form a fibrous pack 66 of base fibers comingled with thermoset binder fibers. Such a configuration and its operation have been described in more detail in U.S. Pat. Nos. 5,523,031 and 5,523,032 to Ault, et al., in connection with the delivery of thermoplastic or molten polymer binders. That disclosure is incorporated herein by reference so that further description here is not necessary.

### Thermoset Binder Fiber Products

The term “fibrous products” is general and encompasses a variety of compositions, articles of manufacture, and manufacturing processes. “Fibrous products” may be characterized and categorized by many different properties; density for example, which may range broadly from about 0.2 pounds/cubic foot (“pcf”) to as high as about 10 pcf, depending on the product. Low density flexible insulation batts and blankets typically have densities between about 0.2 pcf and about 5 pcf, more commonly from about 0.3 to about 4 pcf and are often used for residential insulation in walls, attics and basements. Fibrous products also include higher density products having densities from about 1 to about 10 pcf, more typically from about 2 or 3 pcf to about 8 pcf, such as boards and panels or formed products. Higher density insulation products may be used in industrial and/or commercial applications, including but not limited to metal building wall and ceiling insulation, pipe or tank insulation, insulative ceiling and wall panels, duct boards and HVAC insulation, appliance and automotive insulation, etc.

Other properties useful for categorization of fibrous products include: shape, rigidity and method of manufacture. Residential insulation batts are typically quite flexible and they can be compressed into rolls or batts while recovering their “loft” upon decompression. In contrast, other fibrous products, such as ceiling tiles, wall panels, foundation boards and certain pipe insulation to mention a few, are quite rigid and inflexible by design. These products will flex very little and are unlikely to be adapted or conformed to a particular space. Flexible fibrous products can be forced to assume conforming shapes, while others are formed and shaped for a specific purpose. In some embodiments, the shape is substantially planar, as in duct boards, ceiling tiles and some wall insulation. In other embodiments, the fibrous insulation product is manufactured with a particular shape (e.g. cylindrical) suitable for a particular size conduit, pipe or tank. In other cases, specific shapes and cutouts, often die-cut, are included in certain appliance insulation products, automotive insulation products and the like. Finally, other shapes may be created with nonwoven textile insulation products.

As noted above, fibrous products with thermoset binder fibers can be made by a wide variety of processes, including rotary fiberization, carding or other blending, and wet-laid or air-laid dispersions to name a few.

### EXAMPLES

### Example 1

### % Solids and Viscosity

Thermoset binder having a dry weight composition of 76.2% maltodextrin, 19% citric acid and 4.8% sodium hypophosphite, was prepared in varying concentration sample dispersions with solids content of 8.5%, 20%, 30%, 40%, 50%, 60% and 70%. The viscosity of each sample was measured using a Brookfield viscometer at room temperature. Selection of suitable spindles and speeds using a Brookfield viscometer is within the purview of one having ordinary skill in the art. Exemplary spindles used include at least spindle Nos. 61, 62, 63 and 64 and speeds used include at least 20, 50 and 100 RPM, depending on viscosity. The results are plotted in FIG. 3, (points labeled “Maltodextrin natural binder”) which illustrates the approximately exponential relationship between solids content and viscosity. Also plotted in FIG. 3 is viscosity data obtained from the literature for polyacrylic and phenolic thermoset binder systems. All data points fit relatively well to an exponential regression trend line (R²=0.90).

### Example 2

### Thermoset Binder Fibers

Thermoset fibers were prepared from a sample dispersion from Example 1 having 70% solids. The fibers were made in the lab at room temperature using a 6 inch diameter plastic rotary spinner spun at 1200 rpm and having a single orifice having a diameter of 0.041 inches. Samples of the spun fiber were examined by scanning electron microscopy (SEM) and by transmitted light optical microscopy at 400× magnification with a digital filar eyepiece. The distribution of fiber diameters (100 pts) was determined to be as set forth in Table 1, below.

TABLE 1
Thermoset fiber diameters

| Diameter | % in each |
|---|---|
| (microns) | size category |
| 1 to 3 | 15 |
| 3 to 5 | 25 |
| 5 to 7 | 21 |
| 7 to 9 | 11 |
| 9 to 11 | 9 |
| 11 to 13 | 6 |
| 13 to 15 | 5 |
| >15 | 8 |
| Total | 100 |

### Example 3

### Fibrous Product Made from Thermoset Binder Fibers

Thermoset fibers as prepared in Example 2 were blown down onto a small sample of an unbonded glass fiber handsheet using a low-pressure annular blower located next to the spinner. After stopping the spinner, the handsheet with thermoset binder fibers was removed and a second unbonded handsheet was placed on top, with the thermoset binder fibers between the two unbonded handsheets. This sandwich was placed in a lab oven and cured. Upon removal from the oven and cooling, bonding between the handsheets was observed.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A fiber consisting essentially of curable thermoset compounds in an aqueous dispersion, said dispersion having at least one of the following properties: (a) a viscosity of at least about 30 cps at room temperature; and (b) a concentration of solids of at least about 35%.

2. The fiber of claim 1 wherein said dispersion has a viscosity of at least about 50 cps.

3. The fiber of claim 1 wherein said dispersion has a viscosity of at least about 100 cps.

4. The fiber of claim 1 wherein said dispersion has a concentration of solids of at least about 40%.

5. The fiber of claim 1 wherein said dispersion has a concentration of solids of at least about 50%.

6. The fiber of claim 1 wherein said thermoset compounds are selected from compounds having reactive carboxylic groups, reactive hydroxyl groups, reactive amide groups and reactive amine groups.

7. The fiber of claim 6 wherein said thermoset compounds are selected from carbohydrates and poly-carboxylic acids.

8. The fiber of claim 7 wherein said thermoset compounds are selected from maltodextrins and a poly-carboxylic acid selected from citric, malonic, succinic and maleic.

9. The fiber of claim 6 wherein said thermoset compounds are selected from phenolic and formaldehyde compounds.

10. A method of making a binding fiber, comprising forcing a viscous aqueous dispersion of a curable thermoset compound through an orifice to form a thermoset fiber, said aqueous dispersion having at least one of the following properties: (a) a viscosity of at least about 30 cps at room temperature; and (b) a concentration of solids of at least about 35%.

11. The method of claim 10, wherein said aqueous dispersion has a viscosity of at least about 50 cps.

12. The method of claim 10, wherein said dispersion has a concentration of solids of at least about 40%.

13. The method of claim 10 wherein said thermoset compound is selected from compounds having reactive carboxylic groups, reactive hydroxyl groups, reactive amide groups and reactive amine groups.

14. The method of claim 13 wherein said thermoset compound is selected from carbohydrates and poly-carboxylic acids.

15. The method of claim 10, wherein the step of forcing a viscous aqueous dispersion of a curable thermoset compound through an orifice comprises using centrifugal force in a rotary spinner.

16. The method of claim 10, wherein the step of forcing a viscous aqueous dispersion of a curable thermoset compound through an orifice comprises using a pressure head through a bushing orifice.

17. The method of claim 10, further comprising blending the formed thermoset fiber with other polymeric or inorganic base fibers.

18. The method of claim 17 wherein the blending step comprises a step selected from (a) co-fiberization of the thermoset fiber and an inorganic mineral base fiber; (b) carding the thermoset fiber and the base fiber together; and (c) fluid dispersion of thermoset fibers and base fibers.

19. The method of claim 17, wherein the thermoset fiber is intricately intermingled with base fibers to form a pack of randomly oriented base fibers and thermoset fibers, and further comprising curing the thermoset binder in the pack.

20. A cured fibrous product made by the method of claim 19.

21. An insulative product comprising:
a plurality of base fibers randomly oriented in a fibrous pack; and
a cured thermosetting binder securing the base fibers in random orientation within the fibrous pack, wherein the thermosetting binder originated as a plurality of binder fibers intermingled with the base fibers, the binder fibers consisting essentially of curable thermoset compounds in a fiberizable aqueous dispersion, said dispersion having at least one of the
following properties: (a) a viscosity of at least about 30 cps at room temperature; and (b) a concentration of solids of at least about 35%.

22. The insulative product of claim 21 wherein said dispersion has a viscosity of at least about 50 cps.

23. The insulative product of claim 21 wherein said dispersion has a concentration of solids of at least about 40%.

24. The insulative product of claim 21 wherein said thermoset compounds are selected from compounds having reactive carboxylic groups, reactive hydroxyl groups, reactive amide groups and reactive amine groups.

25. The insulative product of claim 24 wherein said thermoset compounds are selected from carbohydrates and poly-carboxylic acids.
